(19) United States
(12) Patent Application Publication
(10) Pub. No.: US 2025/0141243 A1
(43) Pub. Date: May 1, 2025

(54) TEMPERATURE DETECTION CIRCUIT, CHIP, AND SYSTEM

(71) Applicant: Shanghai Natlinear Electronics Co., Ltd., Shanghai (CN)

(72) Inventors: Guizhi LIU, Shanghai (CN); Xiaoqiang JIANG, Shanghai (CN)

(73) Assignee: Shanghai Natlinear Electronics Co., Ltd., Shanghai (CN)

(21) Appl. No.: 18/702,328

(22) PCT Filed: Oct. 19, 2022
(86) PCT No.: PCT/CN2022/126031

§ 371 Date: Apr. 18, 2024

(30) Foreign Application Priority Data
Jun. 30, 2022 (CN) 2022107720563

(51) Int. Cl. H02J 7/00; G01K 3/10; G01K 7/22; H01M 10/48

(52) U.S. Cl. CPC H02J 7/00309; G01K 3/10; G01K 7/22; H01M 10/486

(57) ABSTRACT

A temperature detection circuit is provided. The temperature detection circuit includes an enable signal generation module and a detection output module. The enable signal generation module is configured to segmentally generate four detection enable signals. The detection output module is connected to an output terminal of the enable signal generation module, and is configured to segmentally generate four thresholds based on the four detection enable signals, and sequentially compare the four thresholds with a detection value. A charging-prohibited signal is valid when a low temperature protection or a high temperature protection is triggered, and a charging-prohibited/discharging-prohibited signal is valid when an ultra-low temperature protection or an ultra-high temperature protection is triggered. The temperature detection circuit of the present disclosure addresses several issues associated with existing lithium battery temperature protection chips, including difficulties in controlling temperature detection results, unstable accuracy, and a cumbersome trimming process due to excessive variables.

### FIELD OF THE INVENTION

The present disclosure relates to integrated circuit design, and in particular, to a temperature detection circuit, a temperature detection chip, and a temperature detection system.

### BACKGROUND OF THE INVENTION

As the use of lithium batteries continues to expand, ensuring their protection becomes increasingly crucial. In everyday scenarios, if a lithium battery's temperature becomes too high or too low, attempting to charge or discharge it can lead to battery damage. Therefore, effective battery temperature detecting and adjusting charging and discharging paths accordingly are of utmost importance.

FIG. 1 depicts a traditional lithium battery temperature detection chip. It utilizes an operational amplifier (OP), an NMOS transistor (MN1), and resistors R1 and R2 to constitute a negative feedback structure, resulting in a constant current I1=VREF1/(R1+R2). Switches K1 and K2 are trimming fuses and are used for trimming the resistance value of R2. PMOS transistors MP1 and MP2 constitute a current mirror, creating an NTC pin current INTC=N*I1=N*VREF1/(R1+R2) with a mirror ratio of 1:N. Additionally, a thermistor voltage

VNTC=INTC*RNTC=(N*VREF1/(R1+R2))*RNTC is generated across the thermistor RNTC.

A thermistor's resistance decreases as the temperature rises. To account for this, different reference voltages are provided based on the thermistor's resistance values at different temperatures. These reference voltages include high temperature reference (VREF2), ultra-high temperature reference (VREF3), low temperature reference (VREF4), and ultra-low temperature reference (VREF5). The thermistor voltages are respectively compared with corresponding reference voltages using four comparators (CMP1, CMP2, CMP3, and CMP4) to generate temperature detection results. These results are then processed through corresponding delayers (De1, De2, De3, and De4) to produce control signals. After passing through logic signal processing circuits, these control signals turn into drive signals (OC and OD) to drive the charging NMOS transistor (MN3) and the discharging NMOS transistor (MN4), respectively.

When a charger is connected between BATP and BATN, assuming that other charge and discharge protections are functioning normally, and that the lithium battery is in a high temperature or low temperature state, the lithium battery temperature protection chip needs to output a signal to prohibit charging. Specifically, the drive signal OC is at a low level, and the drive signal OD is at a high level. In this scenario, the discharge NMOS transistor MN4 is turned on, while the charging NMOS transistor MN3 is turned off. Consequently, the charger cannot charge the battery because the discharge NMOS transistor MN4 is turned on, creating a discharging path through body diodes of MN4 and MN3. Conversely, when the discharge NMOS transistor MN4 is turned off, the body diodes of MN3 and MN4 form a charging path.

When BATP is connected to BATN with a load, charger, or left floating, assuming that other charge and discharge protections are functioning normally, and that the battery is in an ultra-high temperature or ultra-low temperature state, the lithium battery temperature protection chip needs to output a signal to prohibit charging or discharging. Specifically, the drive signal OC is at a low level, and the drive signal OD is also at a low level. In this scenario, both the discharge NMOS transistor MN4 and the charging NMOS transistor MN3 are turned off. Consequently, the battery cannot be charged or discharged.

In the traditional technology, there are two trimming variables: NTC pin current and reference voltage. Having too many variables can lead to challenges in controlling temperature detection results, unstable accuracy, and a cumbersome trimming process. Additionally, to achieve high temperature, ultra-high temperature, low temperature, and ultra-low temperature protection for lithium batteries, four comparators are introduced, resulting in a complex circuit structure. Furthermore, at ultra-low temperatures, the resistance value of the thermistor becomes very large, requiring excessively high reference voltages, which can be difficult to implement. Conversely, at ultra-high temperatures, the resistance value of the thermistor becomes very small, necessitating very low reference voltages. In such cases, comparators may struggle to perform comparisons, ultimately compromising the temperature protection function and posing safety risks to users.

### SUMMARY OF THE INVENTION

In view of the above-mentioned shortcomings, the present disclosure provides a temperature detection circuit, a temperature detection chip, and a temperature detection system, which solve the difficulties in controlling temperature detection results, unstable accuracy, and a cumbersome trimming process due to excessive variables.

The temperature detection circuit includes an enable signal generation module and a detection output module.

The enable signal generation module is configured to segmentally generate four detection enable signals including an ultra-low temperature detection enable signal, a low temperature detection enable signal, a high temperature detection enable signal and an ultra-high temperature detection enable signal.

The detection output module is connected to an output terminal of the enable signal generation module, and is configured to segmentally generate four thresholds including an ultra-low temperature threshold, a low temperature threshold, a high temperature threshold, and an ultra-high temperature threshold based on the four detection enable signals, and sequentially compare the four thresholds with a detection value. A charging-prohibited signal is valid when a low temperature protection or a high temperature protection is triggered, and a charging-prohibited/discharging-prohibited signal is valid when an ultra-low temperature protection or an ultra-high temperature protection is triggered.

Optionally, the enable signal generation module includes a timing unit, a total enable signal generation unit, and a detection enable signal generation unit.

The timing unit is configured to generate a power-on signal during power-on, and then perform a timing operation.

The total enable signal generation unit is connected to a signal output terminal of the timing unit, and is configured to generate a total enable signal based on the power-on signal when neither an over-charge protection nor an over-discharge protection is triggered.

The detection enable signal generation unit is connected to a timing output terminal of the timing unit and an output terminal of the total enable signal generation unit, and is configured to segmentally generate the four detection enable signals based on a timing result of the timing unit when the total enable signal is valid.

Optionally, the detection output module includes a segmented detection unit, a result processing unit, and an output control unit.

The segmented detection unit is connected to the output terminal of the enable signal generation module, and is configured to segmentally generate the four thresholds based on the four detection enable signals, and sequentially compare the four thresholds with the detection value and generate a comparison result.

The result processing unit is connected to the output terminal of the enable signal generation module and an output terminal of the segmented detection unit, and is configured to perform a logical operation on the comparison result and the four detection enable signals. A charging protection signal is generated when the low temperature protection or the high temperature protection is triggered, and a charging/discharging protection signal is generated when the ultra-low temperature protection or the ultra-high temperature protection is triggered.

The output control unit is connected to an output terminal of the result processing unit, and is configured to perform an output control on the charging protection signal to make a charging-permitted signal invalid and the charging-prohibited signal valid; or the output control unit is connected to an output terminal of the result processing unit, and is configured to perform an output control on the charging/discharging protection signal to make a charging-permitted/discharging-permitted signal invalid and the charging-prohibited/discharging-prohibited signal valid.

Optionally, the segmented detection unit includes a threshold portion, a detection portion, and a comparison portion.

The threshold portion is connected to the output terminal of the enable signal generation module and an output terminal of the output control unit, and is configured to segmentally generate the four thresholds based on the four detection enable signals, and correspondingly configure four threshold recovery points based on the charging-permitted signal, charging-prohibited signal, charging-permitted/discharging-permitted signal, and charging-prohibited/discharging-prohibited signal.

The detection portion is configured to detect a present temperature based on a thermistor and generate the detection value.

The comparison portion is connected to an output terminal of the threshold portion and an output terminal of the detection portion, and is configured to sequentially compare the four thresholds with the detection value and generate the comparison result.

Optionally, the threshold portion includes a first operational amplifier, a first NMOS transistor, a second NMOS transistor, a third NMOS transistor, a fourth NMOS transistor, a fifth NMOS transistor, a sixth NMOS transistor, a seventh NMOS transistor, an eighth NMOS transistor, a ninth NMOS transistor, a first resistor, a second resistor, a third resistor, a fourth resistor, a fifth resistor, a sixth resistor, a seventh resistor, an eighth resistor, a ninth resistor, a first delayer, a second delayer, a third delayer, a fourth delayer, a first inverter, a second inverter, a third inverter, a fourth inverter, a fifth inverter, a first NOR gate, a second NOR gate, and a third NOR gate. A non-inverting input terminal of the first operational amplifier is connected to a fixed voltage, an inverting input terminal of the first operational amplifier is connected to a first terminal of the first resistor, and an output terminal of the first operational amplifier is connected to a gate of the first NMOS transistor. A source of the first NMOS transistor is connected to a second terminal of the first resistor, and a drain of the first NMOS transistor segmentally generates the four thresholds. The second resistor, the third resistor, the fourth resistor, the fifth resistor, the sixth resistor, the seventh resistor, the eighth resistor, and the ninth resistor are connected in series between the first terminal of the first resistor and the ground. A gate of the second NMOS transistor receives the ultra-low temperature detection enable signal through the first inverter, the second inverter, and the first delayer, a source of the second NMOS transistor is connected to a connection node between the third resistor and the fourth resistor, and a drain of the second NMOS transistor is connected to a connection node between the first resistor and the second resistor. A gate of the third NMOS transistor receives the low temperature detection enable signal through a first input terminal of the first NOR gate, the third inverter, and the second delayer, a source of the third NMOS transistor is connected to a connection node between the fifth resistor and the sixth resistor, and a drain of the third NMOS transistor is connected to the connection node between the third resistor and the fourth resistor. A gate of the fourth NMOS transistor receives the high temperature detection enable signal through a first input terminal of the second NOR gate, the fourth inverter, and the third delayer, a source of the fourth NMOS transistor is connected to a connection node between the seventh resistor and the eighth resistor, and a drain of the fourth NMOS transistor is connected to the connection node between the fifth resistor and the sixth resistor. A gate of the fifth NMOS transistor receives the ultra-high temperature detection enable signal through a first input terminal of the third NOR gate, the fifth inverter and the fourth delayer, a source of the fifth NMOS transistor is grounded, and a drain of the fifth NMOS transistor is connected to the connection node between the seventh resistor and the eighth resistor. A gate of the sixth NMOS transistor receives the charging-permitted/discharging-permitted signal, and a source and a drain of the sixth NMOS transistor are correspondingly connected to two terminals of the third resistor. A gate of the seventh NMOS transistor receives the charging-permitted signal, and a source and a drain of the seventh NMOS transistor are correspondingly connected to two terminals of the fifth resistor. A gate of the eighth NMOS transistor receives the charging-prohibited signal, and a source and a drain of the eighth NMOS transistor are correspondingly connected to two terminals of the seventh resistor. A gate of the ninth NMOS transistor receives the charging-prohibited/discharging-prohibited signal, and a source and a drain of the ninth NMOS transistor are correspondingly connected to two terminals of the eighth resistor. Second input terminals of the first NOR gate, the second NOR gate, and the third NOR gate are connected to an output terminal of the second inverter.

Optionally, the detection portion includes a second operational amplifier, a tenth NMOS transistor and a tenth resistor. A non-inverting input terminal of the second operational amplifier is connected to the fixed voltage, an inverting input terminal of the second operational amplifier is connected to a first terminal of the tenth resistor and an access terminal of the thermistor, and an output terminal of the second operational amplifier is connected to a gate of the tenth NMOS transistor. A source of the tenth NMOS transistor is connected to a second terminal of the tenth resistor, and a drain of the tenth NMOS transistor generates the detection value.

Optionally, the temperature detection circuit further includes a voltage generation module configured to generate the fixed voltage.

Optionally, the voltage generation module includes a constant current source and an eleventh NMOS transistor. An input terminal of the constant current source is connected to a working voltage, and an output terminal of the constant current source is connected to a drain of the eleventh NMOS transistor. A gate of the eleventh NMOS transistor is connected to its drain, a source of the eleventh NMOS transistor is grounded, and the drain of the eleventh NMOS transistor generates the fixed voltage.

Optionally, the voltage generation module further includes a filter capacitor connected between the drain of the eleventh NMOS transistor and the ground.

Optionally, the comparison portion includes a first comparator. A non-inverting input terminal of the first comparator is connected to the output terminal of the threshold portion, an inverting input terminal of the first comparator is connected to the output terminal of the detection portion, and an output terminal of the first comparator generates the comparison result.

Optionally, the result processing unit includes a first D flip-flop, a second D flip-flop, a third D flip-flop, a fourth D flip-flop, a first NAND gate, and a second NAND gate. Data terminals of the first D flip-flop, the second D flip-flop, the third D flip-flop, and the fourth D flip-flop are connected to the output terminal of the segmented detection unit. A clock terminal of the first D flip-flop receives the high temperature detection enable signal, a clock terminal of the second D flip-flop receives the ultra-high temperature detection enable signal, a clock terminal of the third D flip-flop receives the low temperature detection enable signal, and a clock terminal of the fourth D flip-flop receives the ultra-low temperature detection enable signal. A non-inverting output terminal of the first D flip-flop and an inverting output terminal of the third D flip-flop are connected to two input terminals of the first NAND gate, and a non-inverting output terminal of the second D flip-flop and an inverting output terminal of the fourth D flip-flop are connected to two input terminals of the second NAND gate. An output terminal of the first NAND gate generates an initial charging signal, and an output terminal of the second NAND gate generates an initial charging/discharging signal.

Optionally, the result processing unit further includes a second comparator and a third NAND gate. A non-inverting input terminal of the second comparator is grounded, an inverting input terminal of the second comparator is connected to a charger-access-detection voltage, and an output terminal of the second comparator is connected to a first input terminal of the third NAND gate. A second input terminal of the third NAND gate is connected to the output terminal of the first NAND gate, and an output terminal of the third NAND gate generates a charging protection signal.

Optionally, the result processing unit further includes a third comparator and a fourth NAND gate. A non-inverting input terminal of the third comparator is connected to a thermistor-suspension-detection voltage, an inverting input terminal of the third comparator is connected to a set voltage, and an output terminal of the third comparator is connected to a third input terminal of the third NAND gate and a first input terminal of the fourth NAND gate. A second input terminal of the fourth NAND gate is connected to the output terminal of the second NAND gate, and an output terminal of the fourth NAND gate generates the charging/discharging protection signal.

Optionally, the result processing unit further includes a first switch and a second switch. A first terminal of the first switch is connected to the working voltage, a second terminal of the first switch is connected to a first terminal of the second switch and a third input terminal of the fourth NAND gate, and a second terminal of the second switch is grounded.

Optionally, the output control unit includes a fifth delayer, a sixth delayer, a sixth inverter, and a seventh inverter. An input terminal of the fifth delayer receives the charging protection signal, and an output terminal of the fifth delayer is connected to an input terminal of the sixth inverter and generates the charging-permitted signal. An output terminal of the sixth inverter generates the charging-prohibited signal. An input terminal of the sixth delayer receives the charging/discharging protection signal, and an output terminal of the sixth delayer is connected to an input terminal of the seventh inverter and generates the charging-permitted/discharging-permitted signal. An output terminal of the seventh inverter generates the charging-prohibited/discharging-prohibited signal.

The present disclosure further provides a temperature detection chip, including a temperature detection circuit according to any one of the above embodiments.

The present disclosure further provides a temperature detection system, including the temperature detection chip as described above.

The temperature detection circuit, temperature detection chip, and temperature detection system of the present disclosure employ a unique circuit structure. It operates without a reference, variable trimming, or complex adjustments. Instead, it utilizes segmented detection. This innovative design proactively manages charging and discharging paths based on varying environmental temperatures. By doing so, it effectively safeguards lithium batteries from temperature-related damage. The present disclosure relies on current comparison, eliminating the need for a reference and trimming, ensuring high precision and reliability. Additionally, the circuit employs segmented detection at different temperature points, optimizing device utilization and simplifying the overall circuitry. Charger and thermistor access detection, along with ultra-low temperature and ultra-high temperature protection features, have been implemented. Additionally, an optional temperature protection function has been added, giving users more flexibility. These enhancements improve overall functionality and enhance the adaptability of lithium battery temperature protection. The protective and recovery control mechanism ensures precise and effective management of charging and discharging paths triggered by different temperature scenarios, preventing harm to lithium batteries. As described above, this straightforward yet versatile circuit design offers a wide range of applications and functional choices.

### BRIEF DESCRIPTION OF DRAWINGS

FIG. 1 shows a schematic diagram of a temperature detection chip in traditional technology.

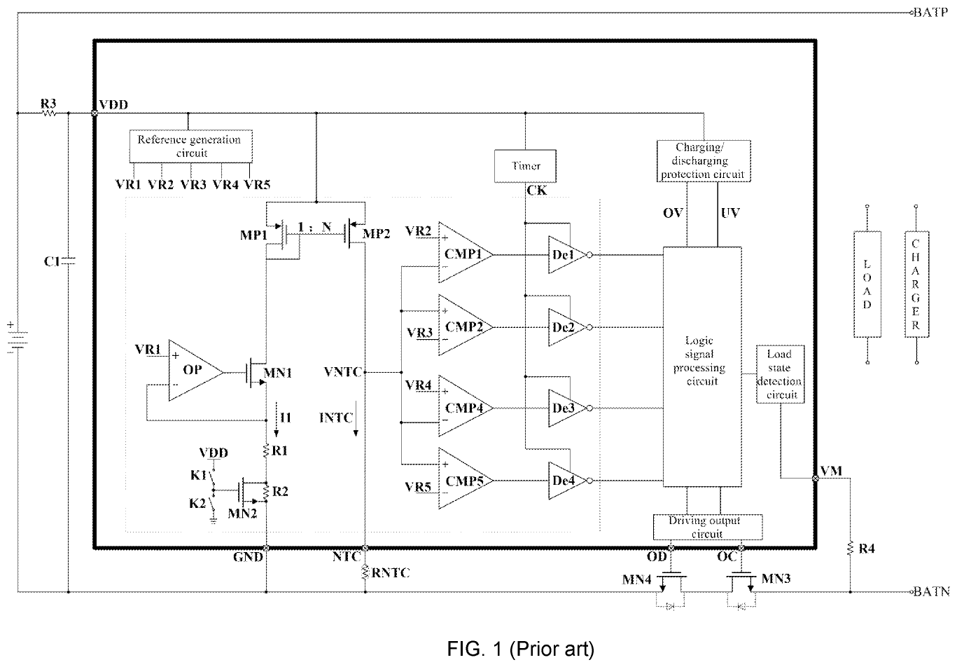

FIG. 2 shows a schematic diagram of a temperature detection chip according to the present disclosure.

FIG. 3 shows a schematic diagram of a detection output module according to the present disclosure.

FIG. 4 shows a timing diagram of a total enable signal, an ultra-low temperature detection enable signal, a low temperature detection enable signal, a high temperature detection enable signal, and an ultra-high temperature detection enable signal according to the present disclosure.

FIG. 5 shows a timing diagram of related signals when a temperature detection circuit of the present disclosure is in high temperature or ultra-high temperature detection.

FIG. 6 shows a timing diagram of related signals when a temperature detection circuit of the present disclosure is in low temperature or ultra-low temperature detection.

### REFERENCE NUMERALS

1 Temperature detection chip
10 Temperature detection circuit
100 Enable signal generation module
101 Timing unit
102 Total enable signal generation unit
103 Detection enable signal generation unit
200 Detection output module
201 Segmented detection unit
2011 Threshold portion
2012 Detection portion
2013 Comparison portion.
202 Result processing unit
203 Output control unit
300 Voltage generation module
20 Charging/discharging protection circuit
30 Load state detection circuit
40 Logic signal processing circuit
50 Driving output circuit

### DETAILED DESCRIPTION OF THE INVENTION

The embodiments of the present disclosure will be described below through exemplary embodiments. Those skilled in the art can easily understand other advantages and effects of the present disclosure according to contents disclosed by the specification. The present disclosure may also be implemented or applied through other different specific implementation modes. Various modifications or changes may be made to all details in the specification based on different points of view and applications without departing from the spirit of the present disclosure.

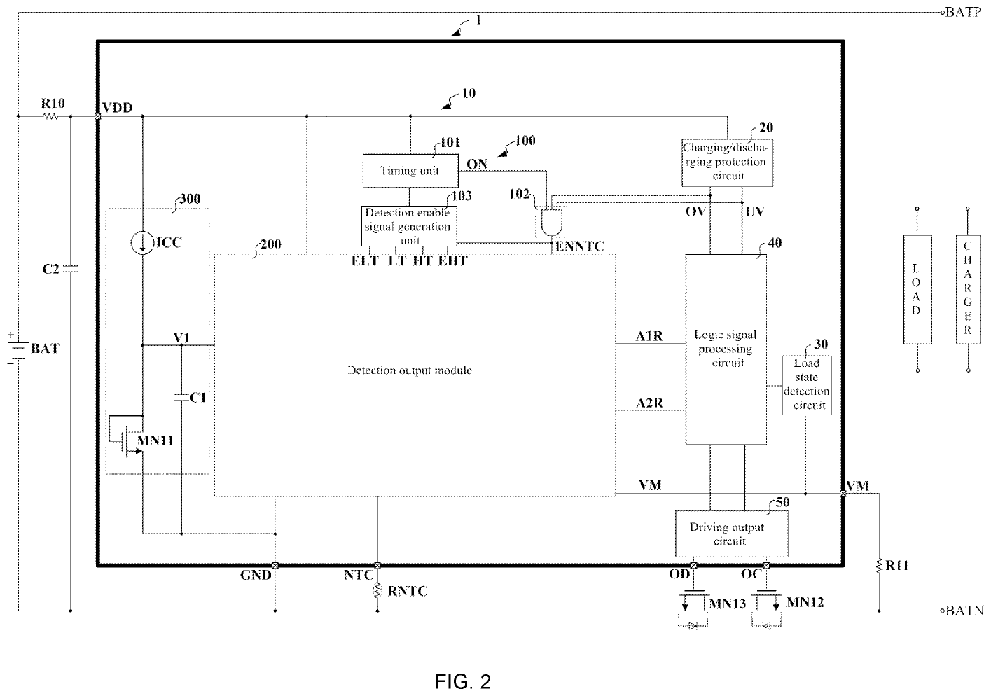

Please refer to FIGS. 2 to 6. It needs to be stated that the drawings provided in the following embodiments are just used for schematically describing the basic concept of the present disclosure, thus only illustrating components only related to the present disclosure and are not drawn according to the numbers, shapes and sizes of components during actual implementation, the configuration, number and scale of each component during actual implementation thereof may be freely changed, and the component layout configuration thereof may be more complex.

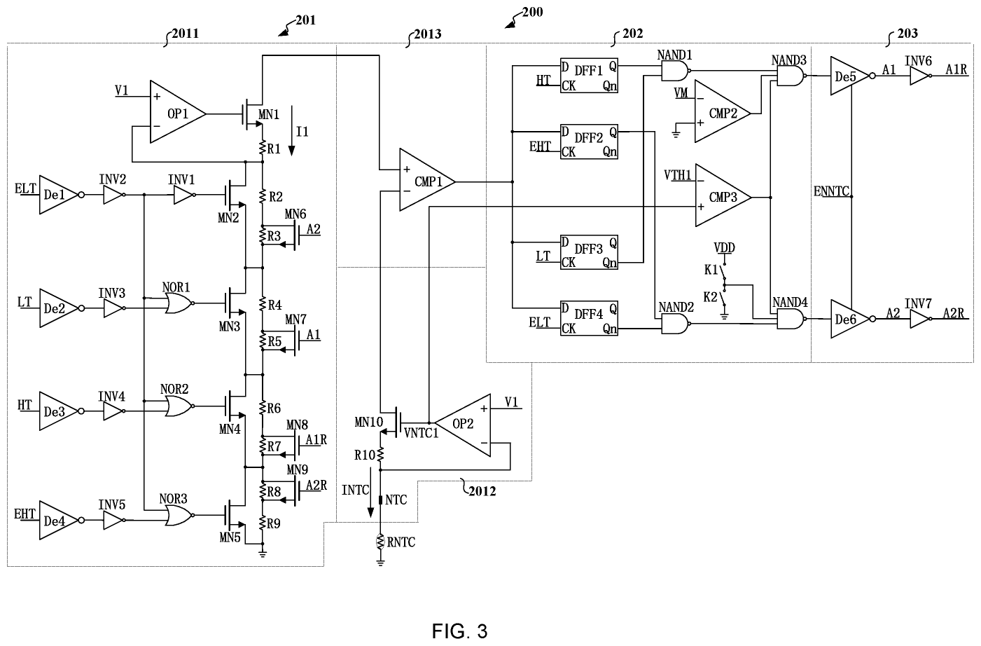

As shown in FIGS. 2 and 3, the present disclosure provides a temperature detection circuit 10, and the temperature detection circuit 10 includes an enable signal generation module 100 and a detection output module 200. The temperature detection circuit 10 further includes a voltage generation module 300.

The enable signal generation module 100 is configured to segmentally generate four detection enable signals including an ultra-low temperature detection enable signal ELT, a low temperature detection enable signal LT, a high temperature detection enable signal HT and an ultra-high temperature detection enable signal EHT.

Specifically, as shown in FIG. 2, the enable signal generation module 100 includes a timing unit 101, a total enable signal generation unit 102, and a detection enable signal generation unit 103.

The timing unit 101 is configured to generate a power-on signal ON during power-on, and then perform a timing operation.

More specifically, the timing unit 101 is implemented by a timer. After the timer is powered on, the power-on signal ON is at a high level, and after the timer is powered down, the power-on signal ON is at a low level.

The total enable signal generation unit 102 is connected to a signal output terminal of the timing unit 101, and is configured to generate a total enable signal ENNTC based on the power-on signal ON when neither an over-charge protection nor an over-discharge protection is triggered.

More specifically, the total enable signal generation unit 102 may be implemented by a three-input AND gate, or may be implemented by a three-input NAND gate and an inverter. The total enable signal ENNTC is generated by performing “AND” logic processing or “NAND and inverting” logic processing on the power-on signal ON, over-charge protection signal OV, and over-discharge protection signal UV, so that the temperature detection circuit 10 stops working when the over-charge protection or over-discharge protection is triggered.

It should be noted that, when the over-charge protection is not triggered, the over-charge protection signal OV is at a high level, and when the over-charge protection is triggered, the over-charge protection signal OV transitions to a low level. Similarly, when the over-discharge protection is not triggered, the over-discharge protection signal UV is at a high level, and when the over-discharge protection is triggered, the over-discharge protection signal UV transitions to a low level.

The detection enable signal generation unit 103 is connected to a timing output terminal of the timing unit 101 and an output terminal of the total enable signal generation unit 102, and is configured to segmentally generate the four detection enable signals based on a timing result of the timing unit 101 when the total enable signal ENNTC is valid.

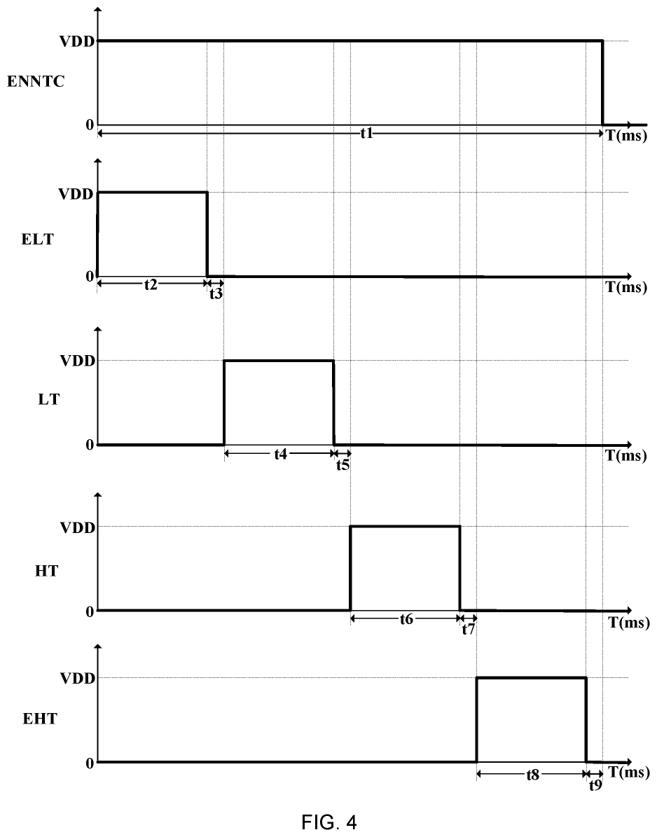

More specifically, the detection enable signal generation unit 103 is implemented by a pulse generation circuit. The pulse generation circuit starts working when the total enable signal ENNTC is valid, and generates a first pulse (i.e., ultra-low temperature detection enable signal ELT) with a duration of t2 when the timer starts timing. After waiting for t3, the pulse generation circuit generates a second pulse (i.e., low temperature detection enable signal LT) with a duration of t4. After waiting for t5, the pulse generation circuit generates a third pulse (i.e., high temperature detection enable signal HT) with a duration of t6. After waiting for t7, the pulse generation circuit generates a fourth pulse (i.e., ultra-high temperature detection enable signal EHT) with a duration of t8. After waiting for t9, one temperature detection ends. Assume a total duration of high levels of the total enable signal ENNTC is t1, then t1=t2+t3+t4+t5+t6+t7+t8+t9, of which, t2=t4=t6=t8 is a duration of each single detection, and t3=t5=t7=t9 is a duration of each dead zone. By configuring durations of single detections and dead zones, errors in temperature detection status can be avoided (as shown in FIG. 4).

The detection output module 200 is connected to an output terminal of the enable signal generation module 100, and is configured to segmentally generate four thresholds including an ultra-low temperature threshold IELT, a low temperature threshold ILT, a high temperature threshold IHT, and an ultra-high temperature threshold IEHT based on the four detection enable signals, and sequentially compare the four thresholds with a detection value. A charging-prohibited signal A1R is valid when a low temperature protection or a high temperature protection is triggered, and a charging-prohibited/discharging-prohibited signal A2R is valid when an ultra-low temperature protection or an ultra-high temperature protection is triggered.

Specifically, as shown in FIG. 3, the detection output module 200 includes a segmented detection unit 201, a result processing unit 202, and an output control unit 203.

The segmented detection unit 201 is connected to the output terminal of the enable signal generation module 100, and is configured to segmentally generate the four thresholds based on the four detection enable signals, and sequentially compare the four thresholds with the detection value and generate a comparison result.

More specifically, the segmented detection unit 201 includes a threshold portion 2011, a detection portion 2012, and a comparison portion 2013.

The threshold portion 2011 is connected to the output terminal of the enable signal generation module 100 and an output terminal of the output control unit 203, and is configured to segmentally generate the four thresholds based on the four detection enable signals, and correspondingly configure four threshold recovery points based on the charging-permitted signal A1, charging-prohibited signal A1R, charging-permitted/discharging-permitted signal A2, and charging-prohibited/discharging-prohibited signal A2R.

The threshold portion 2011 includes a first operational amplifier OP1, a first NMOS transistor MN1, a second NMOS transistor MN2, a third NMOS transistor MN3, a fourth NMOS transistor MN4, a fifth NMOS transistor MN5, a sixth NMOS transistor MN6, a seventh NMOS transistor MN7, an eighth NMOS transistor MN8, a ninth NMOS transistor MN9, a first resistor R1, a second resistor R2, a third resistor R3, a fourth resistor R4, a fifth resistor R5, a sixth resistor R6, a seventh resistor R7, an eighth resistor R8, a ninth resistor R9, a first delayer De1, a second delayer De2, a third delayer De3, a fourth delayer De4, a first inverter INV1, a second inverter INV2, a third inverter INV3, a fourth inverter INV4, a fifth inverter INV5, a first NOR gate NOR1, a second NOR gate NOR2, and a third NOR gate NOR3. A non-inverting input terminal of the first operational amplifier OP1 is connected to a fixed voltage V1, an inverting input terminal of the first operational amplifier OP1 is connected to a first terminal of the first resistor, and an output terminal of the first operational amplifier OP1 is connected to a gate of the first NMOS transistor MN1. A source of the first NMOS transistor MN1 is connected to a second terminal of the first resistor R1, and a drain of the first NMOS transistor MN1 segmentally generates the four thresholds. The second resistor R2, the third resistor R3, the fourth resistor R4, the fifth resistor R5, the sixth resistor R6, the seventh resistor R7, the eighth resistor R8, and the ninth resistor R9 are connected in series between the first terminal of the first resistor R1 and the ground. A gate of the second NMOS transistor MN2 receives the ultra-low temperature detection enable signal ELT through the first inverter INV1, the second inverter INV2, and the first delayer De1, a source of the second NMOS transistor MN2 is connected to a connection node between the third resistor R3 and the fourth resistor R4, and a drain of the second NMOS transistor MN2 is connected to a connection node between the first resistor R1 and the second resistor R2. A gate of the third NMOS transistor MN3 receives the low temperature detection enable signal LT through a first input terminal of the first NOR gate NOR1, the third inverter INV3, and the second delayer De2, a source of the third NMOS transistor MN3 is connected to a connection node between the fifth resistor R5 and the sixth resistor R6, and a drain of the third NMOS transistor MN3 is connected to the connection node between the third resistor R3 and the fourth resistor R4. A gate of the fourth NMOS transistor MN4 receives the high temperature detection enable signal HT through a first input terminal of the second NOR gate NOR2, the fourth inverter INV4, and the third delayer De3, a source of the fourth NMOS transistor MN4 is connected to a connection node between the seventh resistor R7 and the eighth resistor R8, and a drain of the fourth NMOS transistor MN4 is connected to the connection node between the fifth resistor R5 and the sixth resistor R6. A gate of the fifth NMOS transistor MN5 receives the ultra-high temperature detection enable signal EHT through a first input terminal of the third NOR gate NOR3, the fifth inverter INV5, and the fourth delayer De4, a source of the fifth NMOS transistor MN5 is grounded, and a drain of the fifth NMOS transistor MN5 is connected to the connection node between the seventh resistor R7 and the eighth resistor R8. A gate of the sixth NMOS transistor MN6 receives the charging-permitted/discharging-permitted signal A2, and a source and a drain of the sixth NMOS transistor MN6 are correspondingly connected to two terminals of the third resistor R3. A gate of the seventh NMOS transistor MN7 receives the charging-permitted signal A1, and a source and a drain of the seventh NMOS transistor MN7 are correspondingly connected to two terminals of the fifth resistor R5. A gate of the eighth NMOS transistor MN8 receives the charging-prohibited signal A1R, and a source and a drain of the eighth NMOS transistor MN8 are correspondingly connected to two terminals of the seventh resistor R7. A gate of the ninth NMOS transistor MN9 receives the charging-prohibited/discharging-prohibited signal A2R, and a source and a drain of the ninth NMOS transistor MN9 are correspondingly connected to two terminals of the eighth resistor R8. Second input terminals of the first NOR gate NOR1, the second NOR gate NOR2, and third NOR gate NOR3 are connected to an output terminal of the second inverter INV2.

In one embodiment, if the temperature detection circuit 10 is in a condition of no abnormal temperature trigger, the charging-permitted signal A1 is at a low level, and the charging-prohibited signal A1R is at a high level, or the charging-permitted/discharging-permitted signal A2 is at a low level, and the charging-prohibited/discharging-prohibited signal A2R is at a high level.

During ultra-low temperature detection, that is, when the ultra-low temperature detection enable signal ELT is at a high level, the second NMOS transistor MN2, the third NMOS transistor MN3, the fourth NMOS transistor MN4, the fifth NMOS transistor MN5, the sixth NMOS transistor MN6 and the seventh NMOS transistor MN7 are turned off, the eighth NMOS transistor MN8 and the ninth NMOS transistor MN9 are turned on, the effective resistance RELT in series between the first resistor R1 and the ground includes the resistance values of the second resistor R2, the third resistor R3, the fourth resistor R4, the fifth resistor R5, the sixth resistor R6 and the ninth resistor R9, that is, R2+R3+R4+R5+R6+R9=RELT. At this time, the first operational amplifier OP1, the first NMOS transistor MN1, the first resistor R1, the second resistor R2, the third resistor R3, the fourth resistor R4, the fifth resistor R5, the sixth resistor R6, and the ninth resistor R9 constitute a negative feedback structure, resulting in a current I1=ELT=V1/(R2+R3+R4+R5+R6+R9).

During low temperature detection, that is, when the low temperature detection enable signal LT is at a high level, the third NMOS transistor MN3, the sixth NMOS transistor MN6 and the seventh NMOS transistor MN7 are turned off, the second NMOS transistor MN2, the fourth NMOS transistor MN4, the fifth NMOS transistor MN5, the eighth NMOS transistor MN8 and the ninth NMOS transistor MN9 are turned on, the effective resistance RLT in series between the first resistor R1 and the ground includes the resistance values of the fourth resistor R4 and the fifth resistor R5, that is, R4+R5=RLT. At this time, the first operational amplifier OP1, the first NMOS transistor MN1, the first resistor R1, the fourth resistor R4 and the fifth resistor R5 constitute a negative feedback structure, resulting in a current I1=ILT=V1/(R4+R5).

During high temperature detection, that is, when the high temperature detection enable signal HT is at a high level, the fourth NMOS transistor MN4, the sixth NMOS transistor MN6 and the seventh NMOS transistor MN7 are turned off, the second NMOS transistor MN2, the third NMOS transistor MN3, the fifth NMOS transistor MN5, the eighth NMOS transistor MN8 and the ninth NMOS transistor MN9 are turned on, the effective resistance RHT in series between the first resistor R1 and the ground includes the resistance value of the sixth resistor R6, that is, R6=RHT. At this time, the first operational amplifier OP1, the first NMOS transistor MN1, the first resistor R1 and the sixth resistor R6 constitute a negative feedback structure, resulting in a current I1=IHT=V1/R6.

During ultra-high temperature detection, that is, when the ultra-high temperature detection enable signal EHT is at a high level, the fifth NMOS transistor MN5, the sixth NMOS transistor MN6 and the seventh NMOS transistor MN7 are turned off, the second NMOS transistor MN2, the third NMOS transistor MN3, the fourth NMOS transistor MN4, the eighth NMOS transistor MN8 and the ninth NMOS transistor MN9 are turned on, the effective resistance REHT in series between the first resistor R1 and the ground includes the resistance value of the ninth resistor R9, that is, R9=REHT. At this time, the first operational amplifier OP1, the first NMOS transistor MN1, the first resistor R1, and the ninth resistor R9 constitute a negative feedback structure, resulting in a current I1=IEHT=V1/R9.

It is assumed that a resistance value of the thermistor at normal temperature is RNTC, at which time a current flowing through the thermistor is INTC, then REHT<RHT<RNTC<RLT<RELT, and IELT<ILT<INTC<IHT<IEHT.

The sixth NMOS transistor MN6, the seventh NMOS transistor MN7, the eighth NMOS transistor MN8, and the ninth NMOS transistor MN9 are correspondingly controlled by the charging-permitted/discharging-permitted signal A2, charging-permitted signal A1, charging-prohibited signal A1R, and charging-prohibited/discharging-prohibited signal A2R, so as to form the four threshold recovery points including an ultra-low temperature threshold recovery point IELTR, a low temperature threshold recovery point ILTR, a high temperature threshold recovery point IHTR, and an ultra-high temperature threshold recovery point IHTRR.

The detection portion 2012 is configured to detect a present temperature based on the thermistor and generate the detection value INTC.

The detection portion 2012 includes a second operational amplifier OP2, a tenth NMOS transistor MN10, and a tenth resistor R10. A non-inverting input terminal of the second operational amplifier OP2 is connected to the fixed voltage V1, an inverting input terminal of the second operational amplifier OP2 is connected to a first terminal of the tenth resistor R10 and an access terminal of the thermistor, and an output terminal of the second operational amplifier OP2 is connected to a gate of the tenth NMOS transistor MN10. A source of the tenth NMOS transistor MN10 is connected to a second terminal of the tenth resistor R10, and a drain of the tenth NMOS transistor MN10 generates the detection value INTC. Structural parameters of the first operational amplifier OP1 and the second operational amplifier OP2 are the same or substantially the same, width-to-length ratios of the first NMOS transistor MN1 and the tenth NMOS transistor MN10 are the same or substantially the same, and resistance values of the first resistor R1 and the tenth resistor R10 are the same or substantially the same.

In one embodiment, if the resistance value of the thermistor at normal temperature is RNTC, the second operational amplifier OP2, the tenth NMOS transistor MN10, the tenth resistor R10, and the thermistor constitute a negative feedback structure, resulting in a current INTC=V2/RNTC. As the temperature of the lithium battery increases, RNTC decreases, and INTC (i.e., detection value) increases. Similarly, as the temperature of the lithium battery decreases, RNTC increases, and INTC (i.e., detection value) decreases.

The comparison portion 2013 is connected to an output terminal of the threshold portion 2011 and an output terminal of the detection portion 2012, and is configured to sequentially compare the four thresholds with the detection value and generate the comparison result.

The comparison portion 2013 includes a first comparator CMP1. A non-inverting input terminal of the first comparator CMP1 is connected to the output terminal of the threshold portion 2011, an inverting input terminal of the first comparator CMP1 is connected to the output terminal of the detection portion 2012, and an output terminal of the first comparator CMP1 generates the comparison result.

In one embodiment, during ultra-low temperature or low temperature detection, if there is no abnormality (that is, not in an ultra-low temperature or low temperature environment), the first comparator CMP1 outputs a low level, and if there is an abnormality (that is, in an ultra-low temperature or low temperature environment), RNTC increases as the temperature decreases, so that INTC decreases, and the first comparator CMP1 outputs a high level. Similarly, during ultra-high temperature or high temperature detection, if there is no abnormality (that is, not in an ultra-high temperature or high temperature environment), the first comparator CMP1 outputs a high level, and if there is an abnormality (that is, in an ultra-high temperature or high temperature environment), RNTC decreases as the temperature increases, so that INTC increases, and the first comparator CMP1 outputs a low level.

The result processing unit 202 is connected to the output terminal of the enable signal generation module 100 and an output terminal of the segmented detection unit 201, and is configured to perform a logical operation on the comparison result and the four detection enable signals. A charging protection signal is generated when the low temperature protection or the high temperature protection is triggered, and a charging/discharging protection signal is generated when the ultra-low temperature protection or the ultra-high temperature protection is triggered.

More specifically, in a first example, the result processing unit 202 includes a first D flip-flop DFF1, a second D flip-flop DFF2, a third D flip-flop DFF3, a fourth D flip-flop DFF4, a first NAND gate NAND1, and a second NAND gate NAND2. Data terminals of the first D flip-flop DFF1, the second D flip-flop DFF2, the third D flip-flop DFF3, and the fourth D flip-flop DFF4 are connected to the output terminal of the segmented detection unit 201. A clock terminal of the first D flip-flop DFF1 receives the high temperature detection enable signal HT, a clock terminal of the second D flip-flop DFF2 receives the ultra-high temperature detection enable signal EHT, a clock terminal of the third D flip-flop DFF3 receives the low temperature detection enable signal LT, and a clock terminal of the fourth D flip-flop DFF4 receives the ultra-low temperature detection enable signal ELT. A non-inverting output terminal of the first D flip-flop DFF1 and an inverting output terminal of the third D flip-flop DFF3 are connected to two input terminals of the first NAND gate NAND1, and a non-inverting output terminal of the second D flip-flop DFF2 and an inverting output terminal of the fourth D flip-flop DFF4 are connected to two input terminals of the second NAND gate NAND2. An output terminal of the first NAND gate NAND1 generates an initial charging signal, and an output terminal of the second NAND gate NAND2 generates an initial charging/discharging signal. In this case, the result processing unit 202 further includes two inverters (not shown), which are correspondingly connected to the output terminal of the first NAND gate NAND1 and the output terminal of the second NAND gate NAND2, and are configured to invert the initial charging signal and the initial charging/discharging signal, respectively, to correspondingly generate the charging protection signal and the charging/discharging protection signal.

In the first example, in an ultra-low temperature environment, the output of the first comparator CMP1 changes from a low level to a high level, and the fourth D flip-flop DFF4 outputs a low level, and then outputs a low-level charging/discharging protection signal through the second NAND gate NAND2 and the corresponding inverter. In a low temperature environment, the output of the first comparator CMP1 changes from a low level to a high level, and the third D flip-flop DFF3 outputs a low level, and outputs a low-level charging protection signal through the first NAND gate NAND1 and the corresponding inverter. In a high temperature environment, the output of the first comparator CMP1 changes from a high level to a low level, and the first D flip-flop DFF1 outputs a low level, and outputs a low-level charging protection signal through the first NAND gate NAND1 and the corresponding inverter. In an ultra-high temperature environment, the output of the first comparator CMP1 changes from a high level to a low level, and the second D flip-flop DFF2 outputs a low level, and outputs a low-level charging/discharging protection signal through the second NAND gate NAND2 and the corresponding inverter. That is, when the low temperature protection or the high temperature protection is triggered, the charging path is cut off, and when the ultra-low temperature protection or the ultra-high temperature protection is triggered, both the charging path and the discharging path are cut off.

In a second example, the result processing unit 202 includes a first D flip-flop DFF1, a second D flip-flop DFF2, a third D flip-flop DFF3, a fourth D flip-flop DFF4, a first NAND gate NAND1, a second NAND gate NAND2, a third NAND gate NAND3, and a second comparator CMP2. Data terminals of the first D flip-flop DFF1, the second D flip-flop DFF2, the third D flip-flop DFF3, and the fourth D flip-flop DFF4 are connected to the output terminal of the segmented detection unit 201. A clock terminal of the first D flip-flop DFF1 receives the high temperature detection enable signal HT, a clock terminal of the second D flip-flop DFF2 receives the ultra-high temperature detection enable signal EHT, a clock terminal of the third D flip-flop DFF3 receives the low temperature detection enable signal LT, and a clock terminal of the fourth D flip-flop DFF4 receives the ultra-low temperature detection enable signal ELT. A non-inverting output terminal of the first D flip-flop DFF1 and an inverting output terminal of the third D flip-flop DFF3 are connected to two input terminals of the first NAND gate NAND1, and a non-inverting output terminal of the second D flip-flop DFF2 and an inverting output terminal of the fourth D flip-flop DFF4 are connected to two input terminals of the second NAND gate NAND2. An output terminal of the first NAND gate NAND1 is connected to a second input terminal of the third NAND gate, and an output terminal of the second NAND gate NAND2 generates an initial charging/discharging signal. A non-inverting input terminal of the second comparator CMP2 is grounded, an inverting input terminal of the second comparator CMP2 is connected to a charger-access-detection voltage VM, and an output terminal of the second comparator CMP2 is connected to a first input terminal of the third NAND gate NAND3. An output terminal of the third NAND gate NAND3 generates the charging protection signal. In this case, the result processing unit 202 further includes an inverter (not shown), which is connected to the output terminal of the second NAND gate NAND2, and are configured to invert the initial charging/discharging signal to generate the charging/discharging protection signal.

In the second example, compared with the first example, the result processing unit 202 is further configured to perform charging control based on charger-access-detection. The second comparator CMP2 compares the charger-access-detection voltage VM with a ground voltage. If a charger is plugged in, the charger-access-detection voltage VM is less than the ground voltage, the second comparator CMP2 outputs a high level, and at this time, a charging protection caused by the low temperature or high temperature environment is allowed. If no charger is plugged in, the charger-access-detection voltage VM is greater than the ground voltage, the second comparator CMP2 outputs a low level, and at this time, a charging protection caused by the low temperature or high temperature environment is shielded.

In a third example, the result processing unit 202 includes a first D flip-flop DFF1, a second D flip-flop DFF2, a third D flip-flop DFF3, a fourth D flip-flop DFF4, a first NAND gate NAND1, a second NAND gate NAND2, a third NAND gate NAND3, a fourth NAND gate NAND4, a second comparator CMP2, and a third comparator CMP3. Data terminals of the first D flip-flop DFF1, the second D flip-flop DFF2, the third D flip-flop DFF3, and the fourth D flip-flop DFF4 are connected to the output terminal of the segmented detection unit 201 to receive the comparison result. A clock terminal of the first D flip-flop DFF1 receives the high temperature detection enable signal HT, a clock terminal of the second D flip-flop DFF2 receives the ultra-high temperature detection enable signal EHT, a clock terminal of the third D flip-flop DFF3 receives the low temperature detection enable signal LT, and a clock terminal of the fourth D flip-flop DFF4 receives the ultra-low temperature detection enable signal ELT. A non-inverting output terminal of the first D flip-flop DFF1 and an inverting output terminal of the third D flip-flop DFF3 are connected to two input terminals of the first NAND gate NAND1, and a non-inverting output terminal of the second D flip-flop DFF2 and an inverting output terminal of the fourth D flip-flop DFF4 are connected to two input terminals of the second NAND gate NAND2. An output terminal of the first NAND gate NAND1 is connected to a second input terminal of the third NAND gate, and an output terminal of the second NAND gate NAND2 is connected to a second input terminal of the fourth NAND gate NAND4. A non-inverting input terminal of the second comparator CMP2 is grounded, an inverting input terminal of the second comparator CMP2 is connected to a charger-access-detection voltage VM, and an output terminal of the second comparator CMP2 is connected to a first input terminal of the third NAND gate NAND3. A non-inverting input terminal of the third comparator CMP3 is connected to a thermistor-suspension-detection voltage VNTC1, an inverting input terminal of the third comparator CMP3 is connected to a set voltage VTH1, and an output terminal of the third comparator CMP3 is connected to a third input terminal of the third NAND gate NAND3 and a first input terminal of the fourth NAND gate NAND4. An output terminal of the third NAND gate NAND3 generates the charging protection signal, and an output terminal of the fourth NAND gate NAND4 generates the charging/discharging protection signal. It should be noted that, in the third example, the first NAND gate NAND1, the second NAND gate NAND2, and the fourth NAND gate NAND4 are two-input NAND gates, and the third NAND gate NAND3 is a three-input NAND gate.

In the third example, compared with the second example, the result processing unit 202 is further configured to perform charging/discharging control based on thermistor-access-detection. The third comparator CMP3 compares the thermistor-suspension-detection voltage VNTC1 with the set voltage VTH1. If a thermistor is plugged in, the thermistor-suspension-detection voltage VNTC1 is greater than the set voltage VTH1, the third comparator CMP3 outputs a high level, and at this time, a charging protection caused by the low temperature or high temperature environment, and a charging/discharging protection caused by the ultra-low temperature or ultra-high temperature environment are allowed. If no thermistor is plugged in, the thermistor-suspension-detection voltage VNTC1 is less than the set voltage VTH1, the third comparator CMP3 outputs a low level, and at this time, a charging protection caused by the low temperature or high temperature environment, and a charging/discharging protection caused by the ultra-low temperature or ultra-high temperature environment are shielded.

Further, the result processing unit 202 includes a first switch K1 and a second switch K2. A first terminal of the first switch K1 is connected to a working voltage VDD, a second terminal of the first switch K1 is connected to a first terminal of the second switch K2 and a third input terminal of the fourth NAND gate NAND4, and a second terminal of the second switch K2 is grounded. It should be noted that, in the third example, the first NAND gate NAND1 and the second NAND gate NAND2 are two-input NAND gates, and the third NAND gate NAND3 and the fourth NAND gate NAND4 are three-input NAND gates.

In the third example, the first switch K1 and second switch K2 are functional trimming fuses, in order for the circuit to have a wider application range. When the first switch K1 is connected and the second switch K2 is disconnected, a connection node between the first switch K1 and the second switch K2 outputs a high level, and at this time, the charging/discharging protection caused by the ultra-low temperature or ultra-high temperature environment are allowed, providing a comprehensive charging/discharging protection in the ultra-low temperature, low temperature, high temperature, and ultra-high temperature environments. When the first switch K1 is disconnected and the second switch K2 is connected, the connection node between the first switch K1 and the second switch K2 outputs a low level, and at this time, the charging/discharging protection caused by the ultra-low temperature or ultra-high temperature environment is shielded, providing charging/discharging protection in the low temperature and high temperature environments. By so designing the first switch K1 and second switch K2, the temperature detection circuit meets a wide range of user requirements on application, improving its flexibility.

The output control unit 203 is connected to an output terminal of the result processing unit 202, and is configured to perform an output control on the charging protection signal to make the charging-permitted signal A1 invalid and the charging-prohibited signal A1R valid; or the output control unit 203 is connected to an output terminal of the result processing unit 202, and is configured to perform an output control on the charging/discharging protection signal to make the charging-permitted/discharging-permitted signal A2 invalid and the charging-prohibited/discharging-prohibited signal A2R valid.

More specifically, the output control unit 203 includes a fifth delayer De5, a sixth delayer De6, a sixth inverter INV6, and a seventh inverter INV7. An input terminal of the fifth delayer De5 receives the charging protection signal, and an output terminal of the fifth delayer De5 is connected to an input terminal of the sixth inverter INV6 and generates the charging-permitted signal A1. An output terminal of the sixth inverter INV6 generates the charging-prohibited signal A1R. An input terminal of the sixth delayer De6 receives the charging/discharging protection signal, and an output terminal of the sixth delayer De6 is connected to an input terminal of the seventh inverter INV7 and generates the charging-permitted/discharging-permitted signal A2. An output terminal of the seventh inverter INV7 generates the charging-prohibited/discharging-prohibited signal A2R. The fifth delayer De5 and sixth delayer De6 are controlled by the total enable signal ENNTC. By so designing the above delayers and inverters, correlated signal output is achieved, while false triggering of temperature protection is avoided, improving the accuracy of temperature detection.

It should be noted that the delayers are configured to delay and inverse the signals, latency of the first delayer De1, the second delayer De2, the third delayer De3, and the fourth delayer De4 are the same and are in the tens of microseconds range, and latency of the fifth delayer De5 and the sixth delayer De6 are the same and are in the millisecond range.

The temperature detection circuit further includes a voltage generation module 300, which is configured to generate the fixed voltage V1.

Specifically, the voltage generation module 300 includes a constant current source ICC and an eleventh NMOS transistor MN11. An input terminal of the constant current source ICC is connected to the working voltage VDD, and an output terminal of the constant current source ICC is connected to a drain of the eleventh NMOS transistor MN11. A gate of the eleventh NMOS transistor MN11 is connected to its drain, a source of the eleventh NMOS transistor MN11 is grounded, and the drain of the eleventh NMOS transistor MN11 generates the fixed voltage V1. More specifically, the voltage generation module 200 further includes a filter capacitor C1 connected between the drain of the eleventh NMOS transistor MN11 and the ground. A bias current is generated through the constant current source ICC, and a clamping diode is formed by shorting the gate and the drain of the eleventh NMOS transistor MN 11, thereby generating the fixed voltage V1.

The present disclosure further provides a temperature detection chip 1, which includes a temperature detection circuit 10 according to any one of the above embodiments. The temperature detection chip 1 further includes a charging/discharging protection circuit 20, a load state detection circuit 30, a logic signal processing circuit 40, and a driving output circuit 50.

The charging/discharging protection circuit 20 is configured to perform a charging and discharging monitoring on a lithium battery, and is configured to make the over-charge protection signal OV valid when the over-charge protection is triggered, and make the over-discharge protection signal UV valid when the over-discharge protection is triggered.

The load state detection circuit 30 is configured to perform an over-current monitoring on a load, and is configured to make an over-current protection signal valid when an over-current protection signal is triggered.

The logic signal processing circuit 40 is connected to an output terminal of the temperature detection circuit 10, an output terminal of the charging/discharging protection circuit 20, and an output terminal of the load state detection circuit 30, and is configured to generate a charging cut-off signal when the charging-prohibited signal A1R or the over-charge protection signal OV is valid, generate a discharging cut-off signal when the over-discharge protection signal UV or the over-current protection signal is valid, and generate both a charging cut-off signal and a discharging cut-off signal when the charging-prohibited/discharging-prohibited signal A2R is valid.

The driving output circuit 50 is connected to an output terminal of the logic signal processing circuit 40, and is configured to perform an output enhancement on the charging cut-off signal and/or the discharging cut-off signal to make a charging driving signal OC and/or a discharging driving signal OD invalid, thereby controlling a charging switch transistor and/or a discharging switch transistor to be turned off.

It should be noted that, the charging/discharging protection circuit 20, load state detection circuit 30, logic signal processing circuit 40, and driving output circuit 50 may all be implemented by existing circuit structures.

In practical applications, the temperature detection chip 1 further includes a power port VDD, a ground port GND, a temperature detection port NTC, a charger-access-detection port VM, a charging driving port OC, and a discharging driving port OD. The power port VDD is configured to provide a working voltage for the temperature detection chip 1. The ground port GND is configured to ground the temperature detection chip 1. The temperature detection port NTC is externally connected to a thermistor RNTC for temperature detection. The charger-access-detection port VM is configured such that a resistor is externally connected to a negative terminal of charger/discharger, thereby determining whether a charger is plugged in based on a port voltage. The charging driving port OC is configured to generate a charging driving signal to turn on or off the charging switch transistor. The discharging driving port OD is configured to generate a discharging driving signal to turn on or off the discharging switch transistor.

The present disclosure further provides a temperature detection system, which includes the temperature detection chip 1 described above. The temperature detection system further includes a lithium battery BAT, a second capacitor C2, a tenth resistor R10, an eleventh resistor R11, a thermistor RNTC, a charging switch transistor MN12, and a discharging switch transistor MN13.

A positive terminal of the lithium battery BAT is connected to a power port VDD of the temperature detection chip 1 through the tenth resistor R10, and serves as a charging and discharging positive terminal BATP. A negative terminal of the lithium battery BAT is grounded. The second capacitor C2 is connected in parallel between the positive terminal and the negative terminal of the lithium battery BAT. The thermistor RNTC is connected between a temperature detection port NTC of the temperature detection chip 1 and the ground. A gate of the charging switch transistor MN12 is connected to a charging driving port OC of the temperature detection chip 1, a source of the charging switch transistor MN12 is connected to a charger-access-detection port VM of the temperature detection chip 1 through the eleventh resistor R11 and serves as a charging and discharging negative terminal BATN, and a drain of the charging switch transistor MN12 is connected to a drain of the discharging switch transistor MN13. A gate of the discharging switch transistor MN13 is connected to a discharging driving port OD of the temperature detection chip 1, and a source is connected to the negative terminal of the lithium battery BAT. A ground port GND of the temperature detection chip 1 is grounded. By connecting a charger or a load between the charging and discharging positive terminal BATP and the charging and discharging negative terminal BATN, the lithium battery can be charged or discharged.

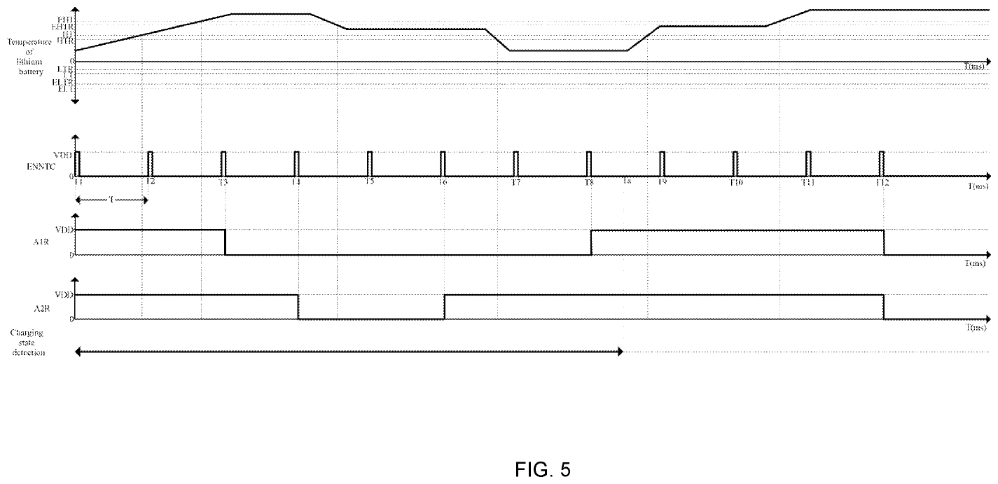

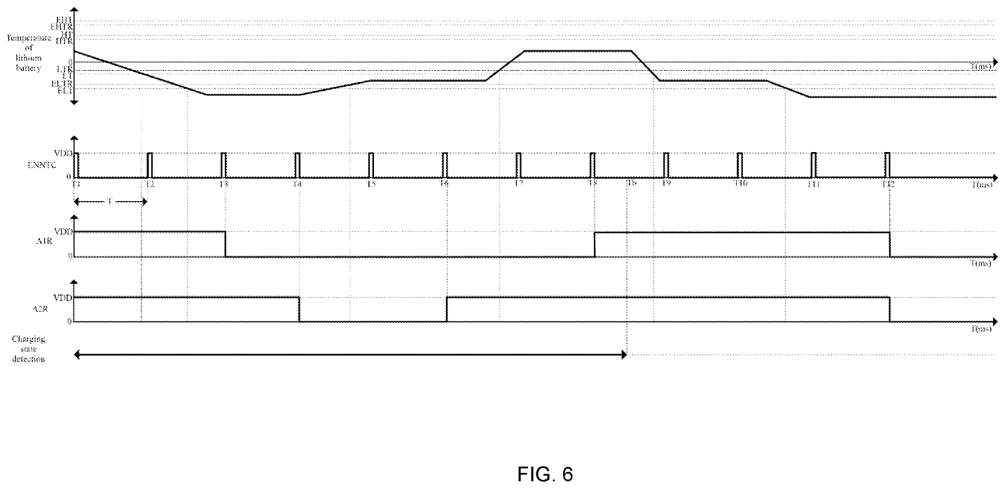

In the following, referring to FIGS. 5 and 6 and in conjunction with FIGS. 2 and 3, an exemplary working process of the temperature detection circuit 10 of the present embodiment will be described. Total enable signal ENNTC is a fixed pulse with a duty cycle of T1/T, T1 is a detection duration of one period, and T-T1 is a delay duration.

When a temperature of the lithium battery rises from a normal temperature to a temperature higher than a high temperature protection point, an abnormal high temperature state is detected in T2, and in T3, the detected temperature of the lithium battery is still higher than the high temperature protection point and is higher than an ultra-high temperature protection point, at which time, if the temperature detection circuit 10 detects that a charger is plugged in, it makes the charging-prohibited signal A1R valid to cut off the charging path. In T4, if the detected temperature of the lithium battery is still higher than the ultra-high temperature protection point, the charging-prohibited/discharging-prohibited signal A2R is valid to cut off the charging path and the discharging path at the same time.

In T5, the detected temperature of the lithium battery is lower than an ultra-high temperature recovery point but still higher than a high temperature recovery point, and in T6, the detected temperature of the lithium battery is still lower than the ultra-high temperature recovery point but higher than the high temperature recovery point, at which time, if the temperature detection circuit 10 detects that the charger is still plugged in, it makes the charging-prohibited/discharging-prohibited signal A2R invalid and maintains the charging-prohibited signal A1R valid to recover the discharging path.

In T7, the detected temperature of the lithium battery is lower than the high temperature recovery point, and in T8, the detected temperature of the lithium battery is still lower than the high temperature recovery point, at which time, the charging-prohibited signal A1R is invalid and the temperature detection circuit 10 returns to a normal state.

After unplugging the charger at Ta, the detected temperature of the lithium battery is higher than the high temperature protection point in T9 and T10, the temperature detection circuit 10 remains normal as no charger is detected. The detected temperature of the lithium battery is higher than the ultra-high temperature protection point in T11 and T12, at which time, the charging-prohibited/discharging-prohibited signal A2R is valid to cut off the charging path and the discharging path at the same time.

When the temperature of the lithium battery falls from a normal temperature to a temperature lower than a low temperature protection point, an abnormal low temperature state is detected in T2, and in T3, the detected temperature of the lithium battery is still lower than the low temperature protection point and is lower than an ultra-low temperature protection point, at which time, if the temperature detection circuit 10 detects that a charger is plugged in, it makes the charging-prohibited signal A1R valid to cut off the charging path. In T4, if the detected temperature of the lithium battery is still lower than the ultra-low temperature protection point, the charging-prohibited/discharging-prohibited signal A2R is valid to cut off the charging path and the discharging path at the same time.

In T5, the detected temperature of the lithium battery is higher than an ultra-low temperature recovery point but still lower than a low temperature recovery point, and in T6, the detected temperature of the lithium battery is still higher than the ultra-low temperature recovery point but lower than the low temperature recovery point, at which time, if the temperature detection circuit 10 detects that the charger is still plugged in, it makes the charging-prohibited/discharging-prohibited signal A2R invalid and maintains the charging-prohibited signal A1R valid to recover the discharging path.

In T7, the detected temperature of the lithium battery is higher than the low temperature recovery point, and in T8, the detected temperature of the lithium battery is still higher than the low temperature recovery point, at which time, the charging-prohibited signal A1R is invalid and the temperature detection circuit 10 returns to a normal state.

After unplugging the charger at Tb, the detected temperature of the lithium battery is lower than the low temperature protection point in T9 and T10, the temperature detection circuit 10 remains normal as no charger is detected. The detected temperature of the lithium battery is lower than the ultra-low temperature protection point in T11 and T12, at which time, the charging-prohibited/discharging-prohibited signal A2R is valid to cut off the charging path and the discharging path at the same time.

In summary, the temperature detection circuit, temperature detection chip, and temperature detection system of the present disclosure employ a unique circuit structure. It operates without a reference, variable trimming, or complex adjustments. Instead, it utilizes segmented detection. This innovative design proactively manages charging and discharging paths based on varying environmental temperatures. By doing so, it effectively safeguards lithium batteries from temperature-related damage. The present disclosure relies on current comparison, eliminating the need for a reference and trimming, ensuring high precision and reliability. Additionally, the circuit employs segmented detection at different temperature points, optimizing device utilization and simplifying the overall circuitry. Charger and thermistor access detection, along with ultra-low temperature and ultra-high temperature protection features, have been implemented. Additionally, an optional temperature protection function has been added, giving users more flexibility. These enhancements improve overall functionality and enhance the adaptability of lithium battery temperature protection. The protective and recovery control mechanism ensures precise and effective management of charging and discharging paths triggered by different temperature scenarios, preventing harm to lithium batteries. As described above, this straightforward yet versatile circuit design offers a wide range of applications and functional choices. Therefore, the present disclosure effectively overcomes various shortcomings in the traditional technology and has high industrial utilization value.

The above-described embodiments are merely illustrative of the principles of the disclosure and its effects, and are not intended to limit the disclosure. Modifications or variations of the above-described embodiments may be made by those skilled in the art without departing from the spirit and scope of the disclosure. Therefore, all equivalent modifications or changes made by those skilled in the art without departing from the spirit and technical concept disclosed by the present disclosure shall be still covered by the claims of the present disclosure.

1. A temperature detection circuit, including an enable signal generation module and a detection output module, wherein:
the enable signal generation module is configured to segmentally generate four detection enable signals including an ultra-low temperature detection enable signal, a low temperature detection enable signal, a high temperature detection enable signal and an ultra-high temperature detection enable signal;
the detection output module is connected to an output terminal of the enable signal generation module, and is configured to segmentally generate four thresholds including an ultra-low temperature threshold, a low temperature threshold, a high temperature threshold, and an ultra-high temperature threshold based on the four detection enable signals, and sequentially compare the four thresholds with a detection value, wherein a charging-prohibited signal is valid when a low temperature protection or a high temperature protection is triggered, and a charging-prohibited/discharging-prohibited signal is valid when an ultra-low temperature protection or an ultra-high temperature protection is triggered.

2. The temperature detection circuit according to claim 1, wherein the enable signal generation module includes a timing unit, a total enable signal generation unit, and a detection enable signal generation unit; wherein
the timing unit is configured to generate a power-on signal during power-on, and then perform a timing operation;
the total enable signal generation unit is connected to a signal output terminal of the timing unit, and is configured to generate a total enable signal based on the power-on signal when neither an over-charge protection nor an over-discharge protection is triggered; and
the detection enable signal generation unit is connected to a timing output terminal of the timing unit and an output terminal of the total enable signal generation unit, and is configured to segmentally generate the four detection enable signals based on a timing result of the timing unit when the total enable signal is valid.

3. The temperature detection circuit according to claim 1, wherein the detection output module includes a segmented detection unit, a result processing unit, and an output control unit;
the segmented detection unit is connected to the output terminal of the enable signal generation module, and is configured to segmentally generate the four thresholds based on the four detection enable signals, and sequentially compare the four thresholds with the detection value and generate a comparison result;
the result processing unit is connected to the output terminal of the enable signal generation module and an output terminal of the segmented detection unit, and is configured to perform a logical operation on the comparison result and the four detection enable signals, wherein a charging protection signal is generated when the low temperature protection or the high temperature protection is triggered, and a charging/discharging protection signal is generated when the ultra-low temperature protection or the ultra-high temperature protection is triggered; and
the output control unit is connected to an output terminal of the result processing unit, and is configured to perform an output control on the charging protection signal to make a charging-permitted signal invalid and the charging-prohibited signal valid;
or
the output control unit is connected to an output terminal of the result processing unit, and is configured to perform an output control on the charging/discharging protection signal to make a charging-permitted/discharging-permitted signal invalid and the charging-prohibited/discharging-prohibited signal valid.

4. The temperature detection circuit according to claim 3, wherein the segmented detection unit includes a threshold portion, a detection portion, and a comparison portion; wherein
the threshold portion is connected to the output terminal of the enable signal generation module and an output terminal of the output control unit, and is configured to segmentally generate the four thresholds based on the four detection enable signals, and correspondingly configure four threshold recovery points based on the charging-permitted signal, charging-prohibited signal, charging-permitted/discharging-permitted signal, and charging-prohibited/discharging-prohibited signal;
the detection portion is configured to detect a present temperature based on a thermistor and generate the detection value; and
the comparison portion is connected to an output terminal of the threshold portion and an output terminal of the detection portion, and is configured to sequentially compare the four thresholds with the detection value and generate the comparison result.

5. The temperature detection circuit according to claim 4, wherein the threshold portion includes a first operational amplifier, a first NMOS transistor, a second NMOS transistor, a third NMOS transistor, a fourth NMOS transistor, a fifth NMOS transistor, a sixth NMOS transistor, a seventh NMOS transistor, an eighth NMOS transistor, a ninth NMOS transistor, a first resistor, a second resistor, a third resistor, a fourth resistor, a fifth resistor, a sixth resistor, a seventh resistor, an eighth resistor, a ninth resistor, a first delayer, a second delayer, a third delayer, a fourth delayer, a first inverter, a second inverter, a third inverter, a fourth inverter, a fifth inverter, a first NOR gate, a second NOR gate, and a third NOR gate;
a non-inverting input terminal of the first operational amplifier is connected to a fixed voltage, an inverting input terminal of the first operational amplifier is connected to a first terminal of the first resistor, and an output terminal of the first operational amplifier is connected to a gate of the first NMOS transistor; a source of the first NMOS transistor is connected to a second terminal of the first resistor, and a drain of the first NMOS transistor segmentally generates the four thresholds; the second resistor, the third resistor, the fourth resistor, the fifth resistor, the sixth resistor, the seventh resistor, the eighth resistor, and the ninth resistor are connected in series between the first terminal of the first resistor and the ground; a gate of the second NMOS transistor receives the ultra-low temperature detection enable signal through the first inverter, the second inverter, and the first delayer, a source of the second NMOS transistor is connected to a connection node between the third resistor and the fourth resistor, and a drain of the second NMOS transistor is connected to a connection node between the first resistor and the second resistor; a gate of the third NMOS transistor receives the low temperature detection enable signal through a first input terminal of the first NOR gate, the third inverter, and the second delayer, a source of the third NMOS transistor is connected to a connection node between the fifth resistor and the sixth resistor, and a drain of the third NMOS transistor is connected to the connection node between the third resistor and the fourth resistor; a gate of the fourth NMOS transistor receives the high temperature detection enable signal through a first input terminal of the second NOR gate, the fourth inverter, and the third delayer, a source of the fourth NMOS transistor is connected to a connection node between the seventh resistor and the eighth resistor, and a drain of the fourth NMOS transistor is connected to the connection node between the fifth resistor and the sixth resistor; a gate of the fifth NMOS transistor receives the ultra-high temperature detection enable signal through a first input terminal of the third NOR gate, the fifth inverter and the fourth delayer, a source of the fifth NMOS transistor is grounded, and a drain of the fifth NMOS transistor is connected to the connection node between the seventh resistor and the eighth resistor; a gate of the sixth NMOS transistor receives the charging-permitted/discharging-permitted signal, and a source and a drain of the sixth NMOS transistor are correspondingly connected to two terminals of the third resistor; a gate of the seventh NMOS transistor receives the charging-permitted signal, and a source and a drain of the seventh NMOS transistor are correspondingly connected to two terminals of the fifth resistor; a gate of the eighth NMOS transistor receives the charging-prohibited signal, and a source and a drain of the eighth NMOS transistor are correspondingly connected to two terminals of the seventh resistor; a gate of the ninth NMOS transistor receives the charging-prohibited/discharging-prohibited signal, and a source and a drain of the ninth NMOS transistor are correspondingly connected to two terminals of the eighth resistor; and second input terminals of the first NOR gate, the second NOR gate, and the third NOR gate are connected to an output terminal of the second inverter.

6. The temperature detection circuit according to claim 4, wherein the detection portion includes a second operational amplifier, a tenth NMOS transistor and a tenth resistor;
a non-inverting input terminal of the second operational amplifier is connected to the fixed voltage, an inverting input terminal of the second operational amplifier is connected to a first terminal of the tenth resistor and an access terminal of the thermistor, and an output terminal of the second operational amplifier is connected to a gate of the tenth NMOS transistor; and a source of the tenth NMOS transistor is connected to a second terminal of the tenth resistor, and a drain of the tenth NMOS transistor generates the detection value.

7. The temperature detection circuit according to claim 5, wherein the temperature detection circuit further includes a voltage generation module configured to generate the fixed voltage.

8. The temperature detection circuit according to claim 7, wherein the voltage generation module includes a constant current source and an eleventh NMOS transistor;
an input terminal of the constant current source is connected to a working voltage, and an output terminal of the constant current source is connected to a drain of the eleventh NMOS transistor; and a gate of the eleventh NMOS transistor is connected to its drain, a source of the eleventh NMOS transistor is grounded, and the drain of the eleventh NMOS transistor generates the fixed voltage.

9. The temperature detection circuit according to claim 8, wherein the voltage generation module further includes a filter capacitor connected between the drain of the eleventh NMOS transistor and the ground.

10. The temperature detection circuit according to claim 4, wherein the comparison portion includes a first comparator;
a non-inverting input terminal of the first comparator is connected to the output terminal of the threshold portion, an inverting input terminal of the first comparator is connected to the output terminal of the detection portion, and an output terminal of the first comparator generates the comparison result.

11. The temperature detection circuit according to claim 3, wherein the result processing unit includes a first D flip-flop, a second D flip-flop, a third D flip-flop, a fourth D flip-flop, a first NAND gate, and a second NAND gate;
data terminals of the first D flip-flop, the second D flip-flop, the third D flip-flop, and the fourth D flip-flop are connected to the output terminal of the segmented detection unit; a clock terminal of the first D flip-flop receives the high temperature detection enable signal, a clock terminal of the second D flip-flop receives the ultra-high temperature detection enable signal, a clock terminal of the third D flip-flop receives the low temperature detection enable signal, and a clock terminal of the fourth D flip-flop receives the ultra-low temperature detection enable signal; a non-inverting output terminal of the first D flip-flop and an inverting output terminal of the third D flip-flop are connected to two input terminals of the first NAND gate, and a non-inverting output terminal of the second D flip-flop and an inverting output terminal of the fourth D flip-flop are connected to two input terminals of the second NAND gate; and an output terminal of the first NAND gate generates an initial charging signal, and an output terminal of the second NAND gate generates an initial charging/discharging signal.

12. The temperature detection circuit according to claim 11, wherein the result processing unit further includes a second comparator and a third NAND gate;
a non-inverting input terminal of the second comparator is grounded, an inverting input terminal of the second comparator is connected to a charger-access-detection voltage, and an output terminal of the second comparator is connected to a first input terminal of the third NAND gate; and a second input terminal of the third NAND gate is connected to the output terminal of the first NAND gate, and an output terminal of the third NAND gate generates a charging protection signal.

13. The temperature detection circuit according to claim 12, wherein the result processing unit further includes a third comparator and a fourth NAND gate;
a non-inverting input terminal of the third comparator is connected to a thermistor-suspension-detection voltage, an inverting input terminal of the third comparator is connected to a set voltage, and an output terminal of the third comparator is connected to a third input terminal of the third NAND gate and a first input terminal of the fourth NAND gate; and a second input terminal of the fourth NAND gate is connected to the output terminal of the second NAND gate, and an output terminal of the fourth NAND gate generates the charging/discharging protection signal.

14. The temperature detection circuit according to claim 13, wherein the result processing unit further includes a first switch and a second switch;
a first terminal of the first switch is connected to the working voltage, a second terminal of the first switch is connected to a first terminal of the second switch and a third input terminal of the fourth NAND gate, and a second terminal of the second switch is grounded.

15. The temperature detection circuit according to claim 13, wherein the output control unit includes a fifth delayer, a sixth delayer, a sixth inverter, and a seventh inverter;
an input terminal of the fifth delayer receives the charging protection signal, and an output terminal of the fifth delayer is connected to an input terminal of the sixth inverter and generates the charging-permitted signal; an output terminal of the sixth inverter generates the charging-prohibited signal; an input terminal of the sixth delayer receives the charging/discharging protection signal, and an output terminal of the sixth delayer is connected to an input terminal of the seventh inverter and generates the charging-permitted/discharging-permitted signal; and an output terminal of the seventh inverter generates the charging-prohibited/discharging-prohibited signal.

16. A temperature detection chip, including the temperature detection circuit according to claim 1.

17. A temperature detection system, including the temperature detection chip according to claim 16.
